(19) United States
(12) Patent Application Publication
(10) Pub. No.: US 2017/0068469 A1
(43) Pub. Date: Mar. 9, 2017

(54) Remote Shared Virtual Disk Snapshot Creation

(71) Applicant: Microsoft Technology Licensing, LLC, Redmond, WA (US)

(72) Inventors: Vinod Shankar, Woodinville, WA (US); Matthew David Kurjanowicz, North Bend, WA (US); Balaji Sekar, Redmond, WA (US); Adam Burch, Redmond, WA (US); Brendan Grebur, Redmond, WA (US)

(73) Assignee: MICROSOFT TECHNOLOGY LICENSING, LLC, Redmond, WA (US)

(21) Appl. No.: 14/844,958

(22) Filed: Sep. 3, 2015

(51) Int. Cl. G06F 3/06

(52) U.S. Cl. CPC G06F 3/0617; G06F 3/065; G06F 3/0664; G06F 3/0683

(57) ABSTRACT

A storage system creates a snapshot of a virtual hard disk by switching an I/O request target for the virtual hard disk. A requestor may issue requests to the storage system requesting that specific operations of the process should be performed. A request may specify that more than one operation should be performed in one operation. After initializing a new virtual hard disk file, I/O requests directed to a target virtual hard disk file are held for later deliver. The I/O request target is switched from the target to the new virtual hard disk file. I/O requests are unblocked and the stored requests are delivered to the new virtual hard disk file. Additional I/O requests sent to the target virtual hard disk file may be redirected to the new virtual hard disk file.

### BACKGROUND

Modern computing environments often utilize virtualized devices in order to provide a level of abstraction above the underlying hardware layer. Such abstraction provides various features, including failure tolerance and ease of administration. Specifically, the use of virtual hard disks in modern computing environments enables simplified data migration, improved failover capabilities, and enhanced data manipulation over traditional physical disks.

It is with respect to these and other considerations that examples of the present disclosure have been contemplated. Furthermore, although a general environment and relatively specific problems have been discussed, it should be understood that the examples described herein should not be limited to the general environment or to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Systems and methods are disclosed herein that enable the creation of virtual hard disk snapshots by a storage system. According to some aspects, a storage system residing on a storage device generates a snapshot of a virtual hard disk (VHD) and the associated target VHD file that backs the VHD. In examples, the storage system may initialize a new VHD file by creating the new VHD file and initializing the file headers. The new VHD file may be associated with a snapshot identifier. Further, the storage system may also update a VHD set file to point to the new VHD file. In some examples, the VHD set file may also be updated to indicate that the snapshot creation process has been initialized.

Further, the storage system may block input/output (I/O) requests during creation of the VHD snapshot. In examples, the storage system may hold I/O requests directed to the VHD and store them in a data store for later delivery. The storage system may switch the target of I/O requests from the underlying target VHD file to the new VHD file. Additionally, the storage system may also unblock I/O requests. In some examples, the storage system may deliver I/O requests stored in the data store to the VHD, more specifically to the underlying new VHD file. Further, the storage system may allow subsequent I/O requests directed to the VHD. The storage system may finalize the VHD and the underlying new VHD file by cleaning up temporary data that was stored during the snapshot creation process. The storage system may also update the VHD set file to indicate that snapshot the creation process is complete.

Examples may be implemented as a computer process, a computing system, or as an article of manufacture such as a computer program product or computer readable media. The computer program product may be a computer storage media readable by a computer system and encoding a computer program of instructions for executing a computer process.

### BRIEF DESCRIPTION OF THE DRAWINGS

Non-limiting and non-exhaustive examples are described with reference to the following figures.

FIG. 1 illustrates a system that may be used to implement examples described herein.

FIG. 2 is an exemplary method for interacting with a VHD.

FIG. 3 is an exemplary method for creating a snapshot.

FIG. 4 is an exemplary method for performing the initialization operation.

FIG. 5 is an exemplary method for performing the block I/O request operation.

FIG. 6 is an exemplary method for performing the switch I/O request target operation.

FIG. 7 is an exemplary method for performing the unblock I/O request operation.

FIG. 8 is an exemplary method for performing the finalization operation.

FIG. 9 is a block diagram illustrating an example of a snapshot creation module.

FIG. 10 is an exemplary method for periodically creating snapshots.

FIG. 11 is a block diagram illustrating an example of a computing device with which aspects of the invention may be practiced.

FIGS. 12A and 12B are simplified block diagrams of a mobile computing device with which aspects of the present invention may be practiced.

FIG. 13 is a simplified block diagram of a distributed computing system in which aspects of the present invention may be practiced.

FIG. 14 illustrates a tablet computing device for executing one or more aspects of the present disclosure.

### DETAILED DESCRIPTION

Various aspects are described more fully below with reference to the accompanying drawings, which form a part hereof, and which show specific exemplary aspects. However, examples may be implemented in many different forms and should not be construed as limited to the examples set forth herein. Accordingly, examples may take the form of a hardware implementation, or an entirely software implementation, or an implementation combining software and hardware aspects. The following detailed description is, therefore, not to be taken in a limiting sense.

Examples of the present disclosure are related to creating snapshots of virtual hard disks (VHDs) within a storage system. In examples, a storage system may be a local device, a network-attached storage device, a distributed file server, or any other type of storage system in a computing environment. VHDs may reside on a standalone server or they may reside in a clustered environment. In the examples disclosed herein, a clustered environment may include one or more storage devices.

In certain aspects, a file name may uniquely identify (for a given execution environment) a single file or directory, enabling a requestor to access the item. In examples, this may be a fully-qualified path to a file, such as: \\server\share\directory1\directory2\filename.ext. In some examples, a file name may also include an alternate data stream identifier. In examples, the alternate data stream may be the characters following a colon character. As a bare example, the NTFS file system would interpret an open of \\server\share\directory1\directory2\filename.ext:XYZZY as requesting the data from an alternate data stream named “XYZZY”. In some examples, a requestor may provide a file name to a storage system in order to access the file or directory identified by the file name. A virtual hard disk (VHD) may be an exposure of a hard disk in a virtual computing environment. As such, a VHD may emulate a single physical hard disk when, in actuality, the VHD is stored across a number of different physical hard disks. In examples, a VHD may have a maximum capacity, which corresponds to a number of sectors in the emulated hard disk. In examples, a VHD may have a physical sector size and/or a logical sector size. In examples, a VHD may have a default logical sector size of 512 bytes or 4096 bytes per sector. In examples, a VHD physical sector size may be an integral multiple of the logical sector size. A virtual hard disk file name may be a file name that uniquely identifies a VHD, enabling a requestor to access the VHD. In examples, the VHD file name may identify a VHD set file. In some examples, a requestor may provide a VHD file name to a storage system in order to access the virtual hard disk identified by the VHD file name. A virtual hard disk file may be a file that is used to store/back-up a VHD. A data structure may be used to track and store data corresponding to the emulated hard disk's sectors. A VHD file may not store all sectors of a VHD. As an example, a VHD file may exclude the data for some (or all) sectors never written or which contain only zero data. In examples, a VHD file may be a differencing VHD. A differencing VHD file may exclude the data for some (or all) sectors where the same data is stored in an ancestor VHD file, and may include a VHD file name for the ancestor VHD file. In other words, a differencing VHD file may track changes between versions or states of a VHD.

A VHD file may be formatted according to the VHDX file format. It may be a fixed VHD file, a dynamic VHD file, or a differencing VHD file. A fixed VHD file is allocated a size and the size of the VHD and does not change when data is added or removed. A dynamic VHD file includes its internal metadata, and dynamically allocates additional space as needed, such as when data is written to the VHD. In examples, a dynamic VHD file's size may correspond to the size of its internal metadata plus the size of the sectors of the VHD which have been written to. In other examples, a dynamic VHD may allocate additional space upon reaching a specific capacity. A differencing VHD file represents the current state of a VHD in comparison to an ancestor VHD file (e.g., a parent VHD file). The VHD file may comprise a header section, a log, blocks, a block allocation table, and a metadata region. The blocks may be payload blocks which contain virtually contiguous pieces of the virtual disk, or sector bitmap blocks that contain pieces of the sector bitmap. The block allocation table may consist of a single contiguous array of entries specifying the state and the physical file offset for each block.

In an example, a client may request access to data stored by a VHD. The VHD may be stored locally (e.g., on a client device), in a remote device (e.g., a remote server or a different storage device in the client clustered environment), or in a clustered environment (e.g., an environment containing multiple storage devices). Various different protocols may be employed to provide access to the VHD. One such protocol is the Server Message Block (SMB) protocol; however, one of skill in the art will appreciate that other application-layer network protocols may be used without departing from the scope of this disclosure. One of skill in the art will also appreciate that the systems and methods disclosed herein may be employed in any other type of environment, such as, but not limited to, a virtual network, a local area network, or a distributed network.

A VHD may be shared among a plurality of requestors. As used herein, a requestor may comprise any device, application, virtual machine, thread, or other process or computing entity requesting access to VHD. In examples, a requestor may access a VHD by providing a VHD file name that uniquely identifies the VHD. One of skill in the art will appreciate that although examples described herein may be described with respect to a “device” or “application” or “client” or “process” or “virtual machine” acting as a requestor, the present disclosure is not limited to a specific type of requestor. When the requestor accesses a VHD, the requestor may provide a VHD file name. The VHD file name may uniquely identify a VHD set file. The VHD set file may be associated with or directly contain one or more snapshot record entries. A snapshot record entry may have a field that specifies what information is being described by the entry such as, for example, an ItemId field. In some examples, the ItemId field may comprise a Globally Unique Identifier (GUID) that provides a type indication (e.g., a Resilient Change Tracking (RCT) ID, an alternate data stream name, a relative file path, an absolute file path, etc.). The snapshot record entry may also comprise a path of the type specified by the ItemId. In examples, a relative or absolute file path may comprise an alternate data stream. The snapshot record entry may describe the location of the VHD file that represents a snapshot described by the snapshot record entry. In implementations, a client may open the VHD set file using the VHD set file name. A resulting file handle from that open may have a target VHD assigned to a predetermined VHD, such as the root VHD, the oldest ancestor, or a most recent snapshot entry. In examples, the initial open of the VHD set file handle associates state with that specific VHD set file handle. In an example, the state may comprise a target VHD. The target VHD may correspond to a VHD file. In examples, the target VHD may be accessed and written to by SCSI PASS THROUGH commands without affecting the VHD set file's data. As such, the VHD set file may be employed to provide a level of indirection between the requestor and the VHD. This ensures that the requestor is able to access data stored by the VHD even if the attributes (e.g., the location, number or type of snapshots, etc.) of the VHD change. In other examples, changes to the VHD set file may be stored in the same directory as the initial VHD set file, thereby allowing the requestor to access different snapshots using the same directory. In one example, when a client knows a desired snapshot's identifier, the client may open the VHD set file using both the VHD set file name and an indication of the snapshot identifier. In other examples, the VHD set file name is combined with an alternate data stream identifier. In examples, a successful file open that includes the desired snapshot's identifier results in a target VHD associated with the file handle being set to the VHD associated with the snapshot identifier. In examples, the target VHD associated with a file handle does not directly affect the data returned for normal file read or write requests through that handle, while nonetheless modifying which VHD are affected by SCSI PASS THROUGH commands sent via that file handle. Further, a requestor may request that the storage system create a snapshot of the VHD. In examples, a requestor may specifically request that the storage system perform specific operations of the snapshot creation process, either one operation individually or several operations simultaneously. In implementations, a requestor would not need to update its configuration to continue to access the virtual hard disk due to another requestor creating a snapshot, for example. In implementations, a requestor would be able to continue to use an existing file handle to a given VHD set file to access the corresponding target VHD associated with that file handle, even where another requestor creates a snapshot against the VHD set file. In implementations, a requestor would be able to continue to use an existing file handle to a given VHD set file to access the corresponding target VHD associated with that file handle, even where an automatic or periodic snapshot is created for the target VHD. The request to perform the specific operations of the snapshot creation process may be provided in a single message or in multiple messages.

In examples, a request message may comprise a SVHDX_META_OPERATION_START_REQUEST message that is sent by a requestor to start a meta-operation on a shared VHD. The request may include a file handle for a VHD set file. The request message may also include an OperationType flag that may be set to SvhdxMetaOperationTypeCreateSnapshot indicating that the meta-operation is part of a snapshot creation process. The request message may also include a SVHDX_META_OPERATION_CREATE_SNAPSHOT structure that is used to send additional parameters for snapshot creation. The SVHDX_META_OPERATION_CREATE_SNAPSHOT structure may include various fields, including Stage1, Stage2, Stage3, Stage4, Stage5, and Stage6. In some examples, one or more StageX variables may indicate a request to perform a specific operation determined by a flag stored by the field. In examples, the flag may be a SvhdxSnapshotStageInitialize flag that indicates the storage system should perform any required initialization so that the appropriate type of snapshot can be taken. The flag may also be a SvhdxSnapshotStageBlockIO flag that indicates that the storage system should temporarily pause all I/O against the target VHD. The flag may also be a SvhdxSnapshotStageSwitchObjectStore flag that indicates that the storage system should switch the current VHD to point to the newly created VHD that results from taking a snapshot. The flag may also be a SvhdxSnapshotStageUnblockIO flag that indicates that the storage system should allow further I/O against the target VHD. The flag may also be a SvhdxSnapshotStageFinalize flag that indicates that the storage system should tear down any state associated with a snapshot of the target VHD. By setting a plurality of stage variables to indicate various operations, it is possible to send one message requesting the performance of multiple operations.

A storage system may receive a request from a client or requestor to initialize a snapshot of a target VHD. In examples, the request may be associated with a VHD file (e.g., a virtual hard disk set file). In some examples, the request may be associated with the VHD set file by being associated with an existing file handle opened to the VHD set file. The target VHD may be an existing VHD that has been the target of I/O operations prior to receiving the snapshot initialization request. In response to receiving the snapshot initialization request, the storage system initializes a new VHD. In implementations, the storage system may create a new VHD file. The new VHD may be associated with a snapshot identifier. The new VHD may be initialized by creating an empty VHD file and initializing file headers. Further, the storage system may also update an associated VHD set file to point to the new VHD. In implementations, a storage system may associate a default or “head” VHD, corresponding to a most recent version of the VHD, with a new file handle to newly created VHD. In examples, a client may provide an indication of a requested VHD to be associated with a new file handle, such as by including a corresponding VHD or branch identifier as an alternate data stream name. In implementations, a default VHD may remain constant while snapshots are added to the corresponding VHD set file (e.g., the snapshots are added to the same root VHD). In other examples, rather than remaining constant, a default VHD may also change while snapshots are added such that the default VHD points to the newest or most recent snapshot. In examples, a target VHD associated with a file handle may be updated without notification to the host, such as when an automatic or periodic snapshot creation occurs. In examples, the storage system may update the VHD set file to indicate that the snapshot creation process has been initialized. In further examples, the storage system may receive an indication that the snapshot creation process should be executed periodically at a specified time interval. Alternatively, a continuous data protection may be performed for the VHD using log files that record actions (such as writes attempted for the corresponding VHD). In such examples, the indication may include a log file name corresponding to a continuous data protection log file.

The storage system may receive a request from a client or requestor to block input/output (I/O) requests directed to the target VHD currently associated with the file handle. In response to receiving the request to block I/O requests, the storage system may store the I/O requests directed to the target VHD in a data store for later delivery rather than delivering the requests to the target VHD. Further, the storage system may block I/O requests directed to the entire VHD, rather than an underlying VHD file. Alternatively, the storage system may block I/O requests to a subset of the VHD. In some examples, I/O requests may be blocked at a virtualized block level or on a VHD file basis. One of skill in the art will appreciate that the level of granularity at which the snapshot process is performed may vary without departing from the spirit of this disclosure.

In some examples, the storage system may receive a request from a client or requestor to switch the target of an I/O request from the target VHD to a new target VHD. In response to receiving the request to switch the I/O request target, the storage system may switch the target of an I/O request from the target VHD to the new target VHD. Switching the I/O request target may comprise providing an indication in the associated VHD set file that I/O requests sent to the VHD set file should be directed to the new VHD file rather than the previous target VHD file. In examples, the target VHD associated with the file handle may be updated to the new target VHD. The storage system may also redirect I/O requests from the target VHD to the new target VHD, wherein redirecting I/O requests may comprise forwarding I/O requests directed to the target VHD to the new VHD instead. In some examples, switching the I/O request target may comprise associating I/O requests with an identifier, where the identifier is changed after receiving the switch I/O target request. This enables the storage system to track I/O requests and differentiate between I/O requests received before and after a snapshot of the VHD was taken.

The storage system may also receive a request from a client or requestor to unblock I/O requests. In response to receiving the request to unblock I/O requests, the storage system may deliver any stored I/O requests. In examples, delivering stored I/O requests may comprise delivering requests to the new VHD rather than the prior target VHD. Further, the storage system may deliver subsequent I/O requests directed to the new VHD, more specifically the new VHD file, rather than holding them in the data store for later delivery. In some examples, the storage system may redirect I/O requests from the target VHD to the new VHD.

The storage system may receive a request from a client or requestor to finalize the snapshot of the VHD (and in examples, the underlying new VHD). In response to receiving the request to finalize the VHD snapshot, the storage system may clean up temporary data that was stored while creating the snapshot. In examples, the storage system may update an entry in the associated VHD set file to indicate that the snapshot creation process is complete. While the examples provided above have been described as being performed with respect to receiving a request to perform the operations individually, in further embodiments, the described operations may be performed in response to receiving a single request that includes all or, alternatively, a subset, of the operations described herein.

The storage system may execute several of the operations described above simultaneously. In examples, the storage system may first initialize a new VHD file. Subsequently, the storage system may block I/O requests associated with the target VHD, switch the I/O request target to the new VHD file, update a file handle's target VHD to the new VHD, unblock I/O requests, and/or finalize (e.g., modify any state associated with a snapshot) the new VHD in one action. In other examples, the storage system may first initialize the new VHD file, subsequently block I/O requests and switch the I/O request target in one action, and then, in discrete actions, unblock I/O requests and finalize the new VHD file. In examples, the storage system may unblock I/O requests prior to finalizing the new VHD file in order to allow I/O request directed toward the new VHD file before the new VHD file has been finalized. In further examples, I/O requests may be directed to the new VHD file as soon as it is created. As such, it may not be necessary to block I/O requests. One of skill in the art will appreciate that the operations described herein may be performed as separate discrete operations or as a combination of multiple operations without departing from the scope of this disclosure.

If the storage system has received an indication that snapshots should be created periodically in order to provide continuous data protection, the storage system may, after a predetermined period of time, execute the snapshot creation process comprising the operations above to create another snapshot. The storage system may then use the new VHD file created above as a target VHD file and subsequently initialize yet another new VHD file having a new snapshot identifier. Then, as described above, the storage system may switch the I/O request target from the target VHD file to the new VHD file. As a result, the associated VHD set file may point to the new VHD file. Further, requests issued to the VHD may be redirected by the storage system to the new VHD file rather than the target VHD file, thereby preserving the target VHD file as the snapshot and maintaining the new VHD file as the current version. Prior to switching the I/O request target, the storage system may block I/O requests directed to the VHD. Similarly, after switching the I/O request target, the storage system may unblock I/O requests directed to the VHD. As such, the operations described herein may be performed periodically in order to continually track the state of a virtual hard disk over time. In examples, this allows clients to (1) continue to use an existing file handle to send commands to a VHD, such as via encapsulated SCSI PASS THROUGH commands, (2) continue to use that existing file handle to read updated metadata, via standard file reads and writes, and (3) avoid updating configuration information corresponding to the file path for subsequently opening the VHD set file. Performing the periodic snapshot operation ensures that a recent snapshot of the VHD is available, thereby ensuring that a recent copy of the VHD exists that can be used to perform a roll back operation in case of an error. Furthermore, the periodic creation of a snapshot may be triggered by an event, such as performing a specific I/O operation or after performing a set number of I/O operations on a target VHD.

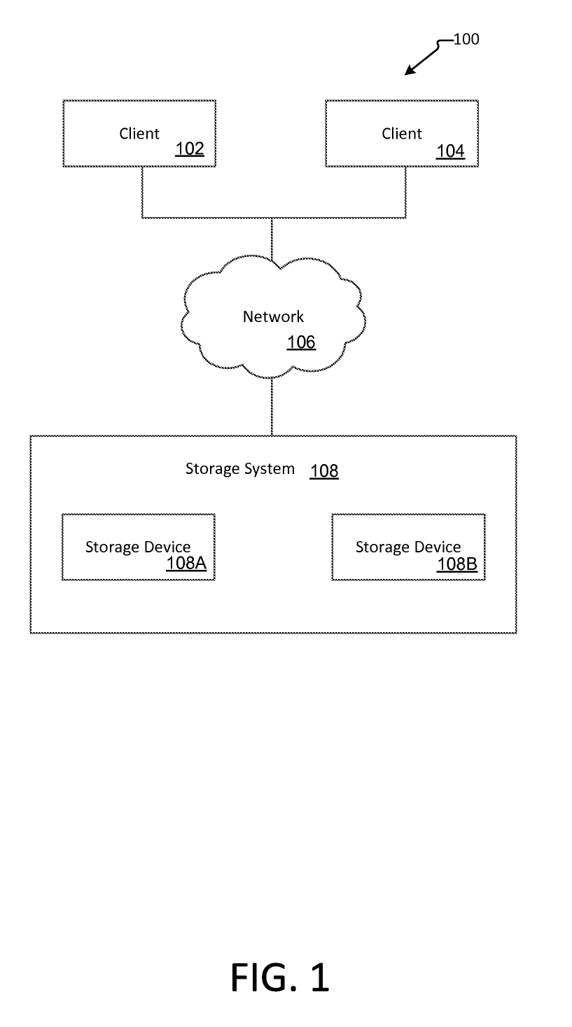

FIG. 1 illustrates a system 100 that may be used to implement the examples disclosed herein. System 100 includes clients 102 and 104. In examples, a client may be a laptop, a tablet, a smartphone, among others. Clients 102 and 104 connect to storage system 108 through a network 106 using, for example, the SMB protocol. For example, network 106 may be a local area network, a wide area network, a cellular data network, the Internet, etc. Storage system 108 stores information that may be accessed by clients 102 and 104. Information stored by system 108 may comprise one or more VHDs (which may be identified by associated VHD set files) and underlying VHD files that may contain the underlying data of the stored VHDs. In examples, clients 102 and 104 maybe considered requestors, as described herein. Although in FIG. 1 only clients 102 and 104 are shown communicating with storage system 108, in other examples there may be more than two clients or fewer than two clients accessing information from storage system 108. In one example, storage system 108 may be a device, such as a server. In alternate examples, the storage system 108 may be a distributed network that includes two or more devices, such as, for example, a cloud network.

FIG. 1 provides an exemplary system 100 for generating snapshots of VHDs. System 100 may include storage system 108, which includes storage devices 108A and 108B. Storage devices 108A and 108B may be physical servers, virtual machine instances, or other computing devices that may be used to make one or more VHDs available to requestors accessing storage system 108. In examples, storage system 108 hosts one or more VHDs that may be accessed by clients 102 and 104. Although two storage devices are shown in FIG. 1, in other examples storage system 108 may include more than two storage devices or fewer than two storage devices.

In examples, client 102 may open a handle to a VHD set file. The handle may be opened using an alternate data stream that indicates a starting target VHD. Upon the client opening the handle, the storage system 108 may associate the file handle with a starting target VHD. The starting target VHD may be an existing VHD, a new VHD, or the most recent snapshot of the VHD. Upon opening the handle to the VHD set file, the client may issue normal read and/or write commands to the VHD set file's data. The VHD set file's data comprises metadata about one or more VHDs accessible using the VHD set file. The VHD set file may also comprise metadata about one or more snapshots for the one or more VHDs. In other words, an accessible VHD may comprise one or more snapshots that may also be accessed using the VHD set file. The client 102 may also issue encapsulated SCSI pass through requests using the open handle. In examples, the encapsulated SCSI pass through requests may be redirected to the target VHD associated with the open handle to the VHD set file. As such, the client 102 may use the handle to the VHD set file to issue I/O request to the target VHD even though the client 102 does not have an open handle to the target VHD itself.

In examples, the client 102 may modify the target VHD associated with the open handle to the VHD set file by requesting generation of a snapshot of the target VHD. Examples related to requesting generation of a snapshot are provided below. In examples, when a snapshot of the target VHD is generated, a new VHD may be created. The new VHD may then be associated with the VHD set file as a new target VHD. As such, the handle to the VHD set file, which client 102 used to issue the request to generate a snapshot, may then be associated with the new target VHD. As such, in examples, the VHD associated with a file handle may change to a newly created, direct descendent differencing VHD or its equivalent. Furthermore, these operations may be performed without requiring the client to open a new handle to submit I/O requests to the new target VHD.

Prior solutions required clients to update a configuration file to point to a differencing disk upon creation of a snapshot. Because of this, the prior solutions required clients to stop submitting I/O requests, close the handle that was opened prior to the creation of the snapshot, and open a new handle to the new differencing disk before the client could issue I/O requests to it. As such, prior solutions resulted in greater client complexity when accessing a VHD upon the creation of a snapshot. Additionally, prior solutions resulted in an increase in network traffic and, in some cases, repeated authentication and authorization, between clients and storage systems. The aspects disclosed herein provide numerous technical benefits over prior solutions. For example, the aspects disclosed herein ensure that client configuration settings for VHD access can refer to at static file while ensuring that a single file open operation (e.g., opening a single handle) will provide access to the latest VHD after a snapshot operation is performed. As such, aspect disclosed herein allow client to continue using existing open file handles to access a VHD even while snapshots are created for a VHD. As such, a client accessing the VHD can request the generation of a snapshot without interrupting access to the VHD by other clients. Additionally, the aspects disclosed herein reduce network traffic associated with the closing a handle to a prior VHD and opening a handle to a new differencing VHD every time a snapshot is created. While specific benefits are described herein, one of skill in the art will recognize that other benefits are achieved through use of the systems and methods disclosed herein.

In accordance with some examples disclosed herein, storage devices 108A and 108B comprise storage system 108 to provide snapshot capabilities for VHDs. Clients 102 and 104 may access one or more VHDs provided via network 106 by storage system 108. Clients 102 and 104 may both simultaneously access the same VHD. In some examples, client 102 may request that storage system 108 initialize a snapshot of a specified VHD. In some examples, the client 102 may request that storage system 108 apply continuous data protection for a specified VHD. The request may also provide an indication of a snapshot creation period that should be executed periodically (e.g., triggered by a passage of time or triggered by the performance of performance of one or more events). In examples, the request may define a predetermined time period or a predetermined event that the periodic creation of snapshots is to be based off of. The request may also provide a log file name that storage system 108 may use to record actions and progress relating to the snapshot creation process. The aspects disclosed herein provide mechanisms which may be employed by the client to define the snapshot creation process. One of skill in the art will appreciate that not all of the mechanisms disclosed herein must be employed by the client when requesting creation of a snapshot. For example, some of the functionality provided by the mechanism may be performed automatically or may not be performed at all without departing from the spirit of this disclosure.

Upon receiving the snapshot initialization request, storage system 108 may initialize a new VHD file. Initializing the new VHD file may comprise creating a new VHD file and initializing headers for the new VHD file. The new VHD file may be associated with a snapshot identifier. In some examples, a VHD set file associated with the specified VHD may be updated to include a reference to the new VHD file for the snapshot. The VHD set file may also be updated to indicate that a snapshot creation process has been initialized.

Client 102 may issue an initialization request to storage system 108 indicating that I/O requests directed to the specified VHD should be blocked. Upon receiving this request, storage system 108 may hold requests directed to the specified VHD (or the underlying VHD file), instead storing them in a data store for later delivery. In some examples, storage system 108 may hold I/O requests directed to the entire specified VHD. Client 104 may issue such an I/O request to storage system 108 for information stored by the specified VHD. Upon receiving the request from client 104, storage system 108 may hold the request and store the request in the data store. In one example, holding the request may include storing the request, for example, in a queue, until the snapshot process has completed.

Client 102 may issue a switch I/O request target request to storage system 108 indicating that the target of I/O requests directed to the specified VHD should be switched from the previous target VHD to the new VHD created in response to receiving the snapshot initialization request. Upon receiving the request from client 102, storage system 108 may switch the target of I/O requests from the target VHD specified by the I/O request to the new VHD. Switching the target of I/O requests may comprise providing an indication in the VHD set file associated with the specified VHD that I/O requests should be directed to the new VHD file rather than the previous target VHD file. In some examples, I/O requests may be redirected from the previous target VHD file to the new VHD file by forwarding I/O requests directed to the VHD to the new VHD file rather than the previous target VHD file.

Client 102 may issue an unblock I/O request to storage system 108 indicating that I/O requests should be unblocked. Upon receiving the request from client 102, storage system 108 may deliver the stored requests from the data store to the VHD file, more specifically to the new VHD file. Additionally, subsequent I/O requests directed to the VHD may be delivered to the new VHD file, rather than holding the I/O requests in the data store for later delivery. In some examples, storage system 108 may redirect subsequent requests from the previous target VHD file to the new VHD file. For example, I/O requests issued by client 104 to storage system 108 for the specified VHD may be directed by storage system 108 to the new VHD file instead of the previous target VHD file.

Client 102 may issue a finalization request to storage system 108 indicating that the snapshot should be finalized. Upon receiving the request from client 102, storage system 108 may clean up temporary data stored during the snapshot creation process. In some examples, the associated VHD set file may be updated to indicate that the snapshot creation process is complete.

One of skill in the art will appreciate that the above description of system 100 is not intended to limit the examples described herein. FIG. 1 and its description are merely intended to illustrate a system for implementing some of the examples disclosed herein. In other examples, different types of components or devices may be included in the system 100 information may be stored on different components in system 100. Thus, examples are not limited to what is shown and described in FIG. 1.

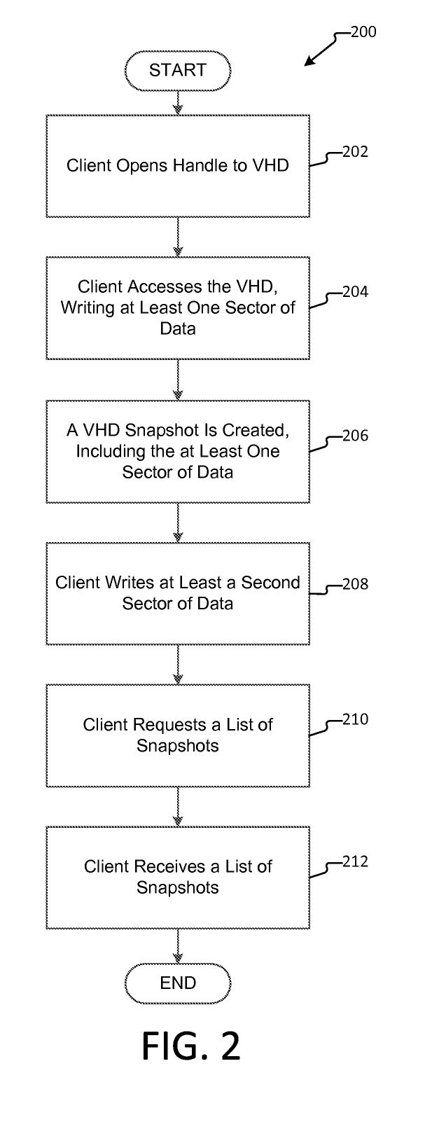

FIGS. 2, 3, 4, 5, 6, 7, and 8 illustrate operational flows 200, 300, 400, 500, 600, 700, and 800 according to examples. Operational flows 200, 300, 400, 500, 600, 700, and 800 may be performed in any suitable computing environment. For example, the operational flows may be executed by systems such as system 100 illustrated in FIG. 1. Therefore, the description of operational flows 200, 300, 400, 500, 600, 700, and 800 may refer to at least one of the components of FIG. 1. However, it is to be understood that the implementations of FIG. 1 are non-limiting environments for operations flows 200, 300, 400, 500, 600, 700, and 800.

Furthermore, although operational flows 200, 300, 400, 500, 600, 700, and 800 are illustrated and described sequentially in a particular order, in other examples, the operations may be performed in different orders, multiple times, and/or in parallel. Further, one or more operations may be omitted or combined in some examples. In addition, it should be understood that ordinals such as “first” are not intended to imply an order or sequence, unless otherwise specified, and are used to distinguish between similar elements. For example, a “first VHD file” need not be an initial VHD file, but should be read to be different from a “second VHD file” or a “third VHD file.”

FIG. 2 illustrates an exemplary method 200 for accessing a VHD. In examples, flow 200 illustrated in FIG. 2 may be performed by a client, e.g. client 102 (FIG. 1). The method 200 may be implemented in hardware, software, or a combination of hardware and software.

Flow begins at operation 202, where a client opens a handle to a VHD set file. As discussed above, the VHD set file may point to a VHD, such as, for example, a current target VHD. The client may open the handle via a file share. In examples, the client may open a handle to the VHD set file by specifying a VHD filename that identifies the requested VHD. For example, referring to FIG. 1, client 102 may open a handle to a VHD set file stored by storage system 108. In other examples, the client may obtain a handle directly to the VHD file. In further examples, the client may submit a request for the handle to the VHD as part of operation 202. At operation 204, the client accesses the VHD, writing at least one sector of data. The client may modify a file stored by the VHD, using the handle opened in operation 202 (i.e., the handle for the VHD set file) to access the VHD. For example, a client may issue SCSI pass through commands to modify the VHD.

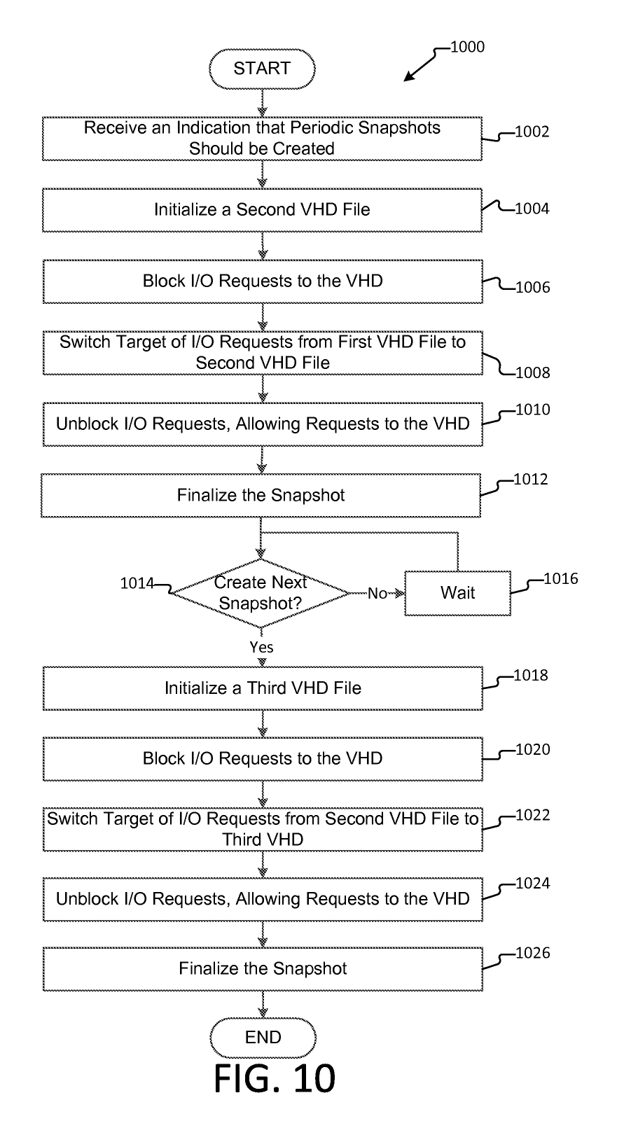

At operation 206, the client may submit a request to create a snapshot of the VHD. In response to the client submitting the request, a snapshot of the VHD may be created by a storage system according to the various aspects disclosed herein. In certain aspects, the snapshot may be created as the result of the periodic creation of snapshots, as will be described further with regards to FIG. 10.0 In such examples, it may not be necessary for the client to submit a request at operation 206. In this example, the snapshot created in response to the request includes the at least one sector of data, e.g., the data written in operation 204, because the snapshot captures the state of the VHD as of the time when the snapshot was taken. In examples, creation of a snapshot may result in the creation of a new VHD. In such examples, the VHD that was accessed at the time of the request to take the snapshot may be held as the snapshot and the new VHD may become the target for subsequent I/O requests. In such examples, the new VHD may be associated with the open handle to the VHD set file as a new target VHD. In other examples, a snapshot may be taken by switching a VHD file backing the VHD such that the contents of old VHD file remain unmodified by future operations while the new VHD file receives future I/O requests. In other examples, the snapshot may be taken by associating I/O requests with an identifier, where the identifier is changed upon taking the snapshot. This enables differentiation between operations that were performed before the snapshot and I/O requests that were received after the snapshot. Upon creation of the new VHD, the handle to the VHD set file remains the same. In other words, the handle to the VHD set file is a static handle that does not change despite a change to the target VHD. As such, the handle to the VHD set file may be able to access the new VHD in the same manner as it accessed the old VHD, which may now be a snapshot.

Flow continues to operation 208. At operation 208, the client writes at least a second sector of data to the VHD. The client may use the handle obtained at operation 202 to issue the write request. In examples, the client may issue SCSI pass through commands using the handle to the VHD set file in order to access and modify data stored by the VHD. As such, the client may interact with the VHD normally, despite the changes resultant of the snapshot creation process. Because the new VHD created during the snapshot is still accessible via the VHD set file, no additional configuration or reconfiguration may be required for the client to interact with the VHD stored by the storage system. Instead, the client may still request writes to the new VHD using the handle to the VHD file previously retrieved. As such, in examples the storage system transparently processes the requests received from the client and directs the requests accordingly such that the snapshot captured at operation 206 continues to reflect the state of the VHD when it was captured, while also allowing further read/write access to the VHD in its current state (e.g., the new target VHD that resulted from the creation of the snapshot). For example, client 102 may continue issuing I/O requests to the VHD stored by storage system 108 after a snapshot of the VHD has been taken. In examples, the storage system may direct I/O requests to a new VHD file while the contents of the old VHD file remain unmodified. In some examples, the storage system may associate new I/O requests with a different identifier than requests received at operation 202, indicating that the new requests were received after the snapshot was created at operation 206.

Flow passes from operation 208 to operation 210, where the client requests a list of snapshots. The client may issue the request via the handle obtained at operation 202. At operation 212, the client receives a list of snapshots. The list of snapshots comprises available snapshots for a specified VHD. The list may identify available snapshots using a snapshot identifier that is associated with each available snapshot. A snapshot identifier may be associated with a snapshot at the time the snapshot is created. For example, client 102 may request a list of available snapshots for a given VHD from storage system 108. Upon receiving the request, storage system 108 may provide client 102 with a list of snapshots, where each snapshot is described by a snapshot identifier. The client may use the list of snapshots to access a prior state of the VHD. The snapshots may be used to perform operations related to error correction, rollbacks, etc.

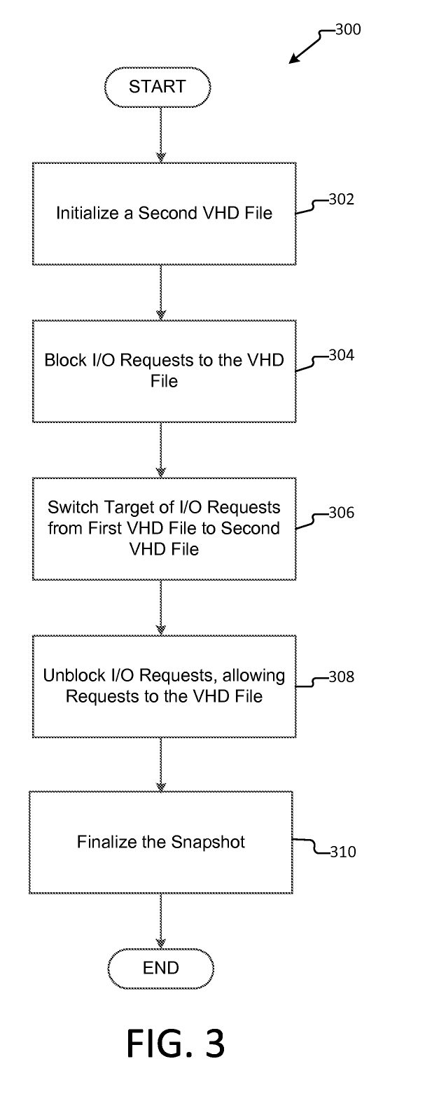

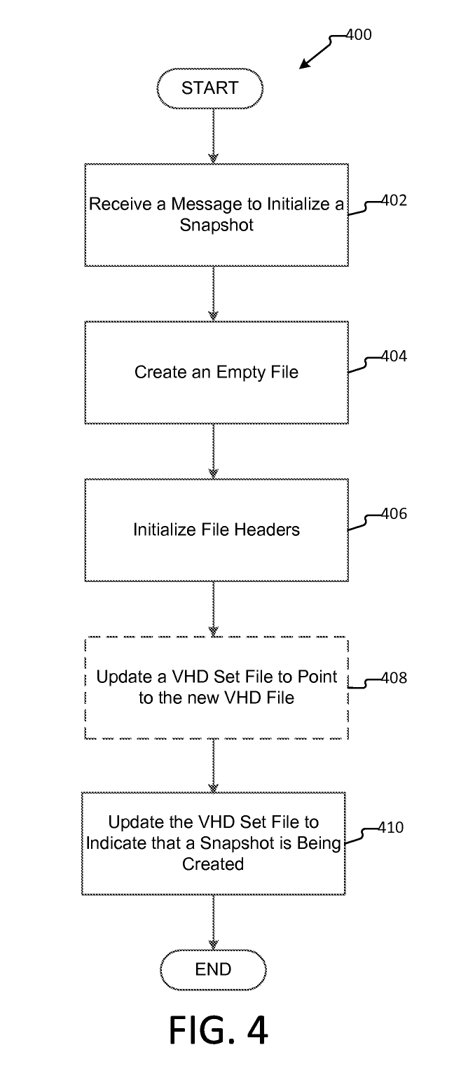

FIG. 3 illustrates an exemplary method for 300 creating a snapshot. In examples, flow 300 illustrated in FIG. 3 may be performed by a storage system, e.g., storage system 108 (FIG. 1). The method 300 may be implemented in hardware, software, or a combination of hardware and software. Flow begins at operation 302, where a second VHD file is initialized. Initializing the second VHD file may comprise creating an empty VHD file and initializing file headers. The second VHD file may be associated with a snapshot identifier. In some examples, a VHD set file may be updated to point to the second VHD file. The VHD set file may also be updated to indicate that the snapshot creation process has been initialized. Additional detail regarding the initialization operation is provided in the discussion accompanying FIG. 4.

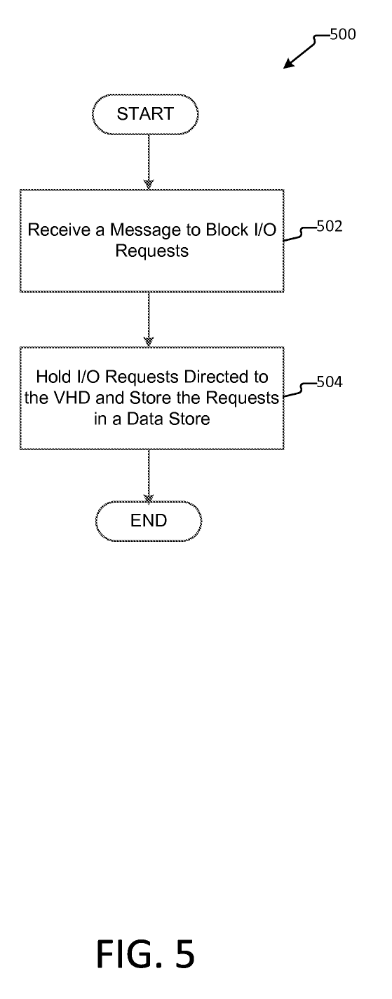

Flow passes from operation 302 to operation 304, where I/O requests directed to the VHD file are blocked. Rather than delivering I/O requests to the first VHD file, the I/O requests may instead be stored in a data store for later delivery. For example, I/O requests for a VHD issued by client 104 to storage system 108 (which would then be directed by storage system 108 to an underlying virtual hard disk file) may be held by storage system, such as storage system 108 of FIG. 1, for later delivery. In alternate examples, I/O requests may be blocked for the entire VHD, rather than just the underlying first VHD file. In such examples, the I/O requests may need to be resubmitted to the file storage system at a later time. Additional detail regarding the block I/O request operation is provided in the discussion accompanying FIG. 5.

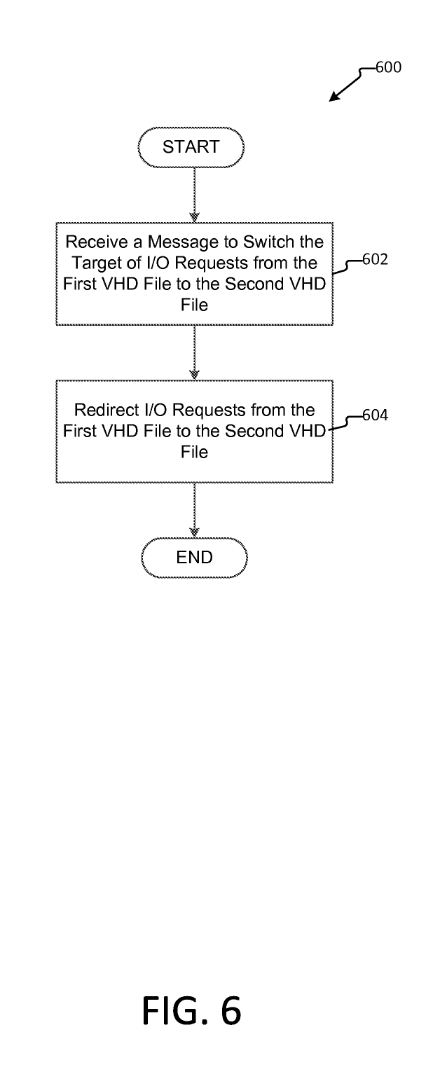

At operation 306, the target of I/O requests may be switched from the first VHD file to the second VHD file. Switching the I/O target preserves the state of the first VHD file, thereby creating a snapshot, while enabling further access and modifications with respect to the second VHD file. In examples, switching the I/O request target may comprise associating I/O requests with an identifier, where the identifier is changed after receiving the switch I/O target request. This enables the storage system to track I/O requests and differentiate between I/O requests received before and after a snapshot of the VHD was taken. In some examples, I/O requests may be redirected from the first VHD file to the second VHD file. Additional detail regarding the switch I/O request target operation is provided in the discussion accompanying FIG. 6.

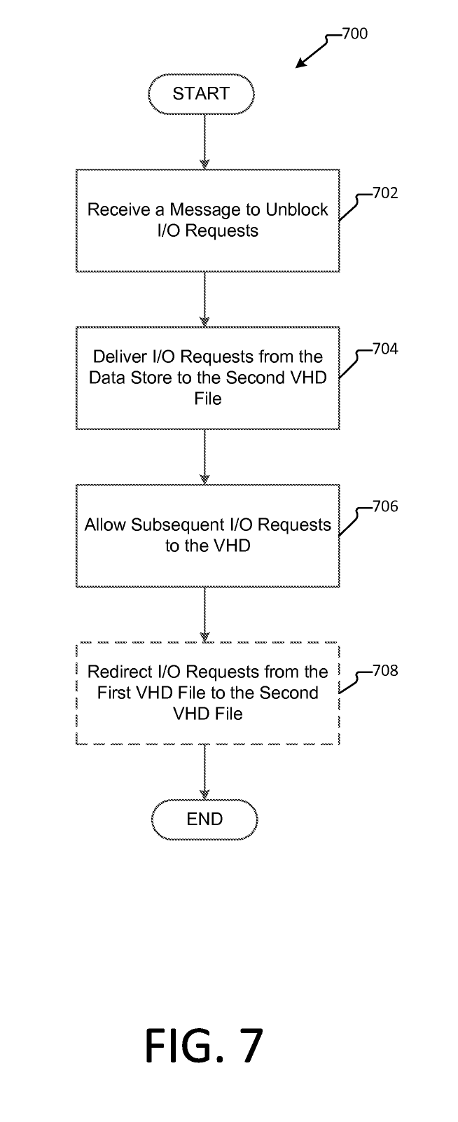

Flow then proceeds to operation 308, where I/O requests are unblocked. During the unblocking operation, the I/O requests may be delivered from the data store to the VHD, more specifically to the second VHD file. Further, subsequent I/O requests directed to the VHD and underlying second VHD file may be allowed. In some examples, I/O requests may be redirected from the first VHD file to the second VHD file. For example, the I/O requests for the VHD issued by a client, such as client 104 of FIG. 1, at operation 304 may be delivered to the second VDH file by storage system 108. Further, additional I/O requests issued by a client directed to the VHD are redirected by the storage system to the second VHD file rather than the first VHD file. Additional detail regarding the unblock I/O request operation is provided in the discussion accompanying FIG. 7.

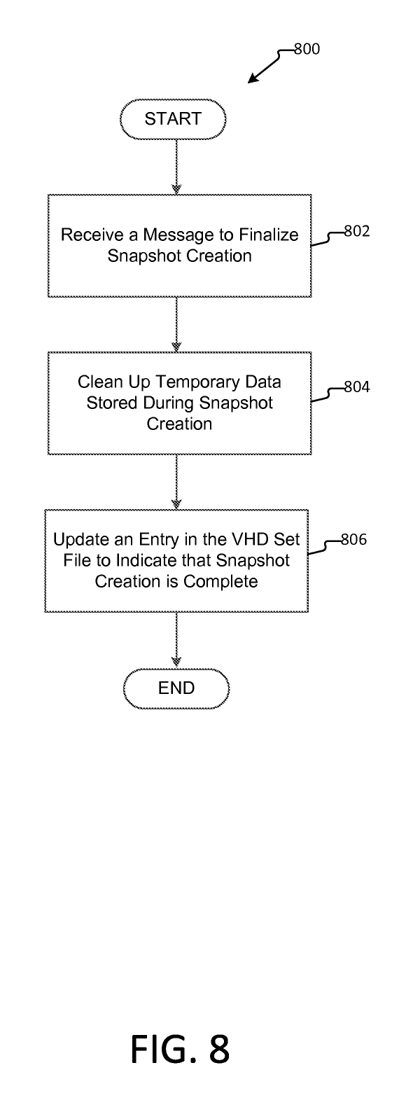

At operation 310, the snapshot is finalized. Temporary data that was stored while creating the snapshot may be cleaned up. An entry in the VHD set file associated with the VHD may be updated to indicate that the snapshot creation process is complete. After operation 310, operational flow ends. Additional detail regarding the finalization operation is provided in the discussion accompanying FIG. 8.

In examples, some or all the operations described above may be executed simultaneously. In some examples, the second VHD file may be initialized, after which the I/O requests may be blocked, the I/O request target may be switched, I/O requests may be unblocked, and the snapshot may be finalized in one operation. For example, a storage system may receive a message from a client comprising a block I/O request, a switch I/O target request, an unblock I/O request, and a finalization request. In some examples, the message from client 102 may indicate the requested operations by first providing a SvhdxSnapshotStageInitialize flag, followed by a message comprising a SvhdxSnapshotStageBlockIO flag, a SvhdxSnapshotStageSwitchObjectStore flag, a SvhdxSnapshotStageUnblockIO, and a SvhdxSnapshotStageFinalize flag. One of skill in the art will appreciate that the flags described herein may be provided separately or in any combination without departing from the scope of this disclosure.

FIG. 4 illustrates an exemplary method for 400 performing the initialization operation. In examples, flow 400 may be performed by a storage system, e.g., storage system 108 (FIG. 1). The method 400 may be performed as part of initialization operation 302 of FIG. 3. The method 400 may be implemented in hardware, software, or a combination of hardware and software.

Method 400 begins at operation 402, where a message requesting the initialization of a snapshot is received. In examples, the request may comprise a SvhdxSnapshotStageInitialize flag, indicating that the storage system should perform any required initialization so that the appropriate type of snapshot can be taken. The message may include a continuous data protection indication that the snapshot creation process should be executed periodically at a specified time interval. The indication may provide a log file name that will be used to log actions and progress relating to the snapshot creation process. For example, storage system 108 may receive an initialization request from client 102.

Flow continues to operation 404, where an empty VHD file is created. The VHD file may be associated with a snapshot identifier. Flow then continues to operation 406 where file headers for the new VHD file created during operation 404 are initialized. Moving to optional operation 408, a VHD set file associated with the VHD may be updated to point to the new VHD file. In examples, a snapshot record entry may be added to the VHD set file. The snapshot record entry may comprise an Repaid field that provides additional information regarding the contents of the entry. In some examples, the ItemId field may comprise a GUID that provides an indication as to the type of snapshot record entry. The entry may also comprise a path to the VHD file that represents the snapshot described by the entry. Operation 408 may be optional because the new VHD file may be created in such a way that the VHD set file will point to it without modification. At operation 410, the VHD set file may be updated to indicate that the snapshot is being created. For example, storage system 108 of FIG. 1, after receiving the initialization request from client 102, may create an empty new VHD file and initialize the file headers. Storage system 108 may also update the associated VHD set file to point to the new VHD file and to indicate that the snapshot is being created. After operation 410, operational flow ends.

FIG. 5 illustrates an exemplary method for 500 performing the block I/O request operation. In examples, method 500 may be performed by a storage system, e.g., storage system 108 (FIG. 1). The method 500 may be performed as part of block I/O request operation 304 of FIG. 3. The method 500 may be implemented in hardware, software, or a combination of hardware and software.

Method 500 begins at operation 502, where a message requesting I/O request blocking is received. In examples, the request may comprise a SvhdxSnapshotStageBlockIO flag, indicating that the storage system should temporarily pause all I/O against the target virtual device (e.g., a VHD). For example, storage system 108 may receive an I/O blocking request from client 102.

Continuing to operation 504, I/O requests directed to the VHD and the underlying first VHD file may be held and instead stored in a data store for later delivery. In examples, the data store may be a queue, in which I/O requests are stored in the data store in first-in-first-out order. In other examples, I/O requests may instead be denied and a message may be returned to the requestor indicating that the I/O requests should be resubmitted at a later time. For example, storage system 108 may hold I/O requests issued by client 104 in a data store for later delivery. After operation 504, operational flow ends.

FIG. 6 illustrates an exemplary method for 600 performing the switch I/O request target operation. In examples, flow 600 may be performed by a storage system, e.g., storage system 108 (FIG. 1). The method 600 may be performed as part of switch I/O request target operation 306 of FIG. 3. The method 600 may be implemented in hardware, software, or a combination of hardware and software.

Method 600 begins at operation 602, where a message to switch the target of I/O requests for a VHD is received. In examples, the request may comprise a SvhdxSnapshotStageSwitchObjectStore flag, indicating that the storage system should switch aspects of the underlying object store so that the appropriate snapshot is taken. At operation 604, I/O requests may be redirected from the first VHD file to the second VHD file underlying the specified VHD. In some examples, I/O requests may be denied and a message may be returned to the requestor indicating that the I/O requests should be resubmitted at a later time. For example, storage system 108 may redirect I/O requests issued by client 104 to storage system 108 from the first VHD file to the second VHD file. After operation 604, operational flow ends.

FIG. 7 illustrates an exemplary method for 700 performing the unblock I/O request operation. In examples, flow 700 may be performed by a storage system, e.g., storage system 108 (FIG. 1). The method 700 may be performed as part of unblock I/O request operation 308 of FIG. 3. The method 700 may be implemented in hardware, software, or a combination of hardware and software.

Method 700 begins at operation 702, where a message to unblock I/O requests is received. At operation 704, I/O requests are delivered from the data store to the VHD, more specifically the requests are delivered to the underlying second VHD file. In examples, the request may comprise a SvhdxSnapshotStageUnblockIO flag, indicating that the storage system should allow further I/O against the target virtual device (e.g., a VHD). In some examples, the data store may be a queue and I/O requests may be popped from the queue and delivered to the second VHD file. Moving to operation 706, subsequent I/O requests directed to the VHD may be allowed. In some examples, a message could be sent to a requestor indicating that I/O requests that were previously denied should be resubmitted at this time. At optional operation 708, I/O requests directed to the first VHD file are redirected to the second VHD file. For example, storage system 108 may receive an unblock I/O request from client 102. Upon receiving the unblock I/O request, storage system 108 may deliver stored I/O requests for the VHD issued by client 104 to the second VHD file. Further, storage system 108 may allow subsequent communications between client 104 and the VHD. In examples, storage system 108 may also direct new requests for the VHD issued by client 104 to the second VHD file rather than the first VHD file. In other examples, it may not be required to redirect I/O requests. For example, the new VHD file may be created such that no modification is required to the VHD set file to point to the new VHD file. In such examples, I/O requests to the old VHD file would automatically be directed to the new VHD file because the handle pointing to the old and new VHD files remains the same. After operation 708, operational flow ends.

FIG. 8 illustrates an exemplary method for 800 performing the finalization operation. In examples, flow 800 may be performed by a storage system, e.g., storage system 108 (FIG. 1). The method 800 may be performed as part of finalization operation 310 of FIG. 3. The method 800 may be implemented in hardware, software, or a combination of hardware and software.

Method 800 begins at operation 802, where a message to finalize snapshot creation received. In examples, the request may comprise a SvhdxSnapshotStageFinalize flag, indicating that the storage system should tear down any state associated with a snapshot of the target virtual device (e.g., a VHD). At operation 802, temporary data stored during snapshot creation is cleaned up. Moving to operation 806, the VHD set file is updated to indicate that the snapshot creation process is complete. For example, a storage system, such as storage system 108 of FIG. 1, may receive a finalization request from a client. Upon receiving the finalization request, storage system 108 may clean up temporary data that was stored during the snapshot creation process (e.g., stored I/O requests that were held as a result of a block I/O requests message). Storage system 108 may also update the VHD set file associated with the VHD to indicate that the snapshot creation process is complete. After operation 806, operational flow ends.

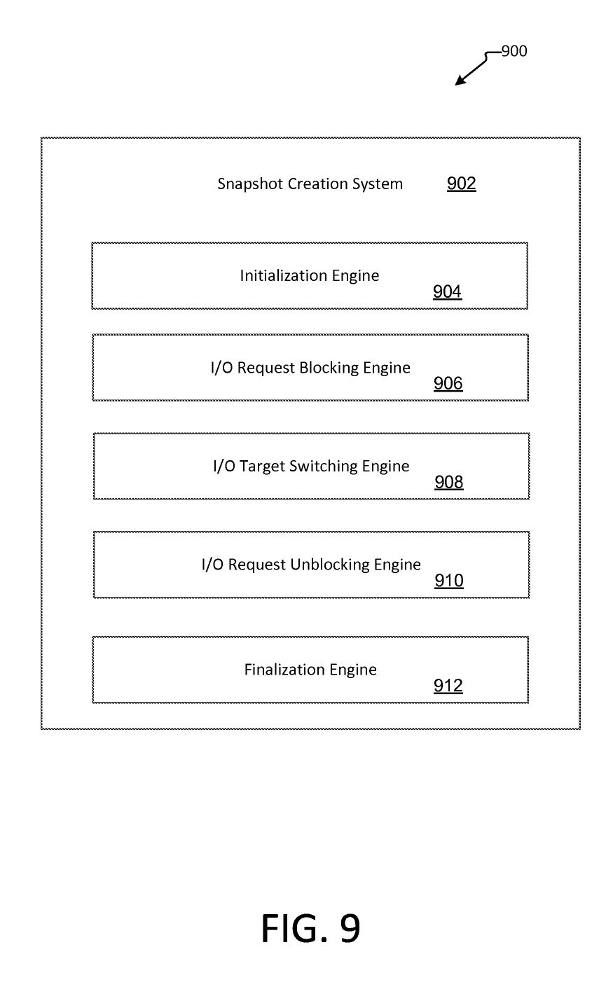

FIG. 9 is a block diagram illustrating the components of a snapshot creation system. Snapshot creation system 902 may include an initialization engine 904, an I/O request blocking engine 906, an I/O target switching engine 908, an I/O request unblocking engine 910, and a finalization engine 912. In examples, the various engines may be implemented using hardware, software, or a combination of hardware and software. Snapshot creation system 902 may be used to create a snapshot of a VHD in order to provide backup or redundancy capabilities. A storage system, such as storage system 108 of FIG. 1, may include the snapshot creation system 902.

Initialization engine 904 may perform initialization operations in order to prepare for creating a snapshot of a VHD. A new VHD file may be created. In examples, initialization engine 904 may also initialize the file headers. A VHD set file associated with the VHD may be updated to include an entry pointing to the new VHD file. The VHD set file may also be updated to indicate that the snapshot creation engine has been initialized. Initialization engine 904 might perform method 400. Initialization engine 904 may comprise initialization means. The initialization means may create a new VHD file that may be the target for I/O requests received after the snapshot creation process. The initialization means may also initialize file headers for the new VHD file by copying relevant I/O headers from a target I/O file and modifying the headers accordingly. The initialization file may also set a “entry point indicator” that can be associated with or written to the VHD set file to identify the newly created VHD file. I/O request blocking engine 906 may block I/O requests directed to the VHD. I/O requests may be stored in a data store for later delivery. I/O request blocking engine 906 might perform method 500. In aspects, the blocking engine 906 may comprise a blocking means for blocking I/O requests. The blocking means may comprise a “blocked indicator” that requests should be blocked and a “blocked I/O” data structure that holds the blocked I/O requests. The blocking means may process an I/O request by checking the indicator to determine if the I/O request should be blocked. If not, the blocking means may allow the I/O request to be processed, such as by being sending the I/O request to the I/O target. Otherwise, the blocking means may add the I/O request to the blocked IO/data structure. The blocked indicator may be one or more bits stored in a memory, one or more hardware circuit lines having predetermined combinations of high or low logic levels, or the like. The blocked JO data structure may be a queue, an ordered list, an unordered list, a linked list, a doubly linked list, a first-in-first-out queue, a first-in-last-out queue, an array of pointers to the blocked JO requests, or any other data structure that allows inserting and removing indicators of blocked JO requests.

I/O target switching engine 908 may switch the target of I/O requests from the previous VHD file to the new VHD file. In examples, I/O requests may be redirected from the previous VHD file to the new VHD file. I/O target switching engine 908 might perform method 600. The target switching engine 908 may comprise a target switching means. The target switching means may comprise an indicator of an I/O target for a virtual hard disk. In examples, a target switching means may comprise a synchronization primitive, such as a mutex, event, spinlock, one or more hardware circuit lines having predetermined combinations of high or low logic levels, or the like. In examples, the I/O target may be a handle to a file, such as a VHDX format file or a continuous data protection log file. In examples, the target switching means tracks the outstanding I/O count for the I/O target. In examples, the target switching means increments a stored value by one for each I/O request sent to the I/O target, and decrements a stored value by one for each I/O request completed by the JO target. In examples, the increment and decrement use atomic operations, such as InterlockedIncrement and InterlockedDecrement. The target switching means may switch targets by swapping the I/O target from a first value to a second value. The target switching means may be implemented using an atomic compare-and-swap. In examples, the target switching means checks if any I/O are outstanding on the I/O target. If no I/O requests are outstanding, the target switching means may immediately swap the I/O target. If any I/O requests are outstanding, the target switching means may swap the I/O target only upon completion of the outstanding I/O requests. In examples, the outstanding I/O requests may be determined by the decrementing of an outstanding I/O request count to a predetermined value, such as zero.

I/O request unblocking engine 910 may deliver I/O requests stored by the data store to the new VHD file. Subsequent I/O requests directed to the VHD may be allowed. In examples, I/O requests directed to the VHD may be directed to the new VHD file rather than the previous VHD file. I/O request unblocking engine 910 might perform method 700. The unblocking engine 910 may comprise unblocking means. In examples, an unblocking means may check if a blocked I/O data structure exists, and/or whether a blocked I/O data structure contains any I/O requests. In examples, the blocking means may repeatedly attempt to remove an I/O request from the blocked I/O data structure until no further requests exist. In examples, a blocking means may atomically remove the blocked I/O data structure or atomically remove all the blocked I/O. In examples, the unblocking means may provide blocked I/O to a blocking means.

Finalization engine 912 may clean up temporary data stored during the snapshot creation process (e.g., stored I/O requests that were held by I/O request blocking module 906). In examples, the VHD set file may be updated to indicate that the snapshot creation engine is complete. Finalization engine 912 might perform method 800. The finalization engine 912 may comprise finalization means. A finalization means may check a temporary data structure to identify temporary data created during the snapshot creation process. The temporary data structure may be one or more bits stored in a memory, one or more hardware circuit lines having predetermined combinations of high or low logic levels, or the like. In examples, the finalization means may cause the temporary data to be deleted or otherwise removed by indicating that the disk space or memory storing the temporary data can be written to by other applications or processes, by overwriting the temporary data, and the like. The finalization means may also set an indicator that is part of or associated with the VHD set file to indicate that the snapshot creation process is complete.

FIG. 10 illustrates a method 1000 according to examples disclosed herein. Method 1000 may be performed in any suitable computing environment. For example, the operations that are part of the method 1000 may be executed by environments such as illustrated in FIG. 1. Therefore, the description of method 1000 may refer to at least one of the components of FIG. 1. However, it is to be understood that the implementations of FIG. 1 are non-limiting environments for operations flow 1000. Furthermore, although operational 1000 is illustrated and described sequentially in a particular order, in other examples, the operations may be performed in different orders, multiple times, and/or in parallel. Further, one or more operations may be omitted or combined in some examples.

FIG. 10 illustrates an exemplary method for 1000 periodically creating snapshots, such as part of a continuous data protection. In examples, flow 1000 may be performed by a storage system, e.g., storage system 108 (FIG. 1). The method 1000 may be implemented in hardware, software, or a combination of hardware and software.

At operation 1002, an indication may be received that periodic snapshots should be created. Moving to operation 1004, a second VHD is initialized, such as a second VHD file. Initializing the second VHD file may comprise creating an empty VHD file and initializing file headers. The second VHD may be associated with a snapshot identifier. In some examples, a VHD set file may be updated to point to the second VHD. The VHD set file may also be updated to indicate that the snapshot creation process has been initialized.

At operation 1006, I/O requests to the VHD are blocked. Rather than delivering I/O requests to the first VHD, the I/O requests may instead be stored in a data store for later delivery. For example, I/O requests for a VHD issued by client 104 to storage system 108 may be held by storage system 108 for later delivery. Further, I/O requests may be blocked for the entire VHD, rather than just the underlying first VHD.

Flow passes from operation 1006 to operation 1008, where the target of I/O requests is switched from the first VHD to the second VHD. In some examples, I/O requests may be redirected from the first VHD to the second VHD.

At operation 1010, I/O requests are unblocked. I/O requests may be delivered from the data store to the VHD, more specifically to the second VHD. Further, subsequent I/O requests directed to the VHD and underlying second VHD may be allowed. In some examples, I/O requests may be redirected from the first VHD to the second VHD. For example, the I/O requests issued by client 104 at operation 1006 are delivered to the second VHD by storage system 108. Further, additional I/O requests issued by client 104 directed to the VHD are redirected by storage system 108 to the second VHD rather than the first VHD.

Flow continues to operation 1012, where the snapshot is finalized. Temporary data that was stored while creating the snapshot may be cleaned up. An entry in the VHD set file associated with the VHD may be updated to indicate that the snapshot creation process is complete.

Flow passes to determination 1014, where a determination is made whether the next snapshot should be created. In examples, this determination may comprise determining whether a requisite amount of time has passed or whether an event trigger has occurred. If it is determined that the next snapshot should not be created, flow passes to operation 1016, where, after waiting, flow returns to determination step 1014. If, however, it is determined that the next snapshot should be created, flow continues to operation 1018.

At operation 1018, a third VHD is initialized, such as by initializing a third VHD file. Initializing the third VHD file may comprise creating an empty VHD file and initializing file headers. The third VHD may be associated with a new snapshot identifier. In some examples, a VHD set file may be updated to point to the third VHD. The VHD set file may also be updated to indicate that the snapshot creation process has been initialized.

At operation 1020, I/O requests to the second VHD are blocked. Rather than delivering I/O requests to the second VHD file, the I/O requests may instead be stored in a data store for later delivery. For example, I/O requests for a VHD issued by client 104 to storage system 108 may be held by storage system 108 for later delivery. Further, I/O requests may be blocked for the entire VHD, rather than just the underlying VHD file.

Flow passes from operation 1020 to operation 1022, where the target of I/O requests is switched from the second VHD to the third VHD. In some examples, I/O requests may be redirected from the second VHD file to the third VHD file.

At operation 1024, I/O requests are unblocked. I/O requests may be delivered from the data store to the VHD, more specifically to the third VHD file. Further, subsequent I/O requests directed to the VHD and underlying third VHD file may be allowed. In some examples, I/O requests may be redirected from the second VHD file to the third VHD file. For example, the I/O requests issued by client 104 at operation 1020 are delivered to the third VHD file by storage system 108. Further, additional I/O requests issued by client 104 directed to the VHD are redirected by storage system 108 to the third VHD file rather than the second VHD file.

Moving to operation 1026, the snapshot is finalized. Temporary data that was stored while creating the snapshot may be cleaned up. An entry in the VHD set file associated with the VHD may be updated to indicate that the snapshot creation process is complete. After operation 1026, operational flow ends.

While the method 1000 describes an exemplary method of performing continuous data protection, alternative mechanisms may be employed to perform continuous data protection. For example, log files may be used to perform continuous data protection. In such examples, a request to perform continuous data protection may include the name of a log file that may be used during the process to record actions and progress relating to the snapshot creation process. In examples, the indication may be received as part of a SVHDX_META_OPERATION_START_REQUEST message that includes an OperationType field and a CdpParameters structure. In examples, the OperationType may be set with the SvhdxMetaOperationTypeCreateSnapshot flag and the CdpParameters structure may include a LogFileNameOffset field, a LogFileId field, and a LogFileName field used to define a log file to track information generated during a continuous data protection operation. In examples, the log file may be used to track and save any writes attempted on a VHD. The writes from the log file may be applied to a VHD file at a different site (e.g., a distinct data center, such as one many thousands of miles away) in order to replicate the VHD. Additionally, the writes from the log file may be used for error correction or recovery.

As disclosed above, a VHD Set File may provide a client a single static handle to a VHD. The client may continue to do all of the following simultaneously: (a) use the same static handle to access the VHD Set File data, (b) write to the VHD by sending tunneled SCSI PASS THROUGH requests via that static handle, (c) being unaware of one or more new snapshots being created as child branches of the VHD, and (d) continuing to write to the VHD by sending tunneled SCSI PASS THROUGH requests via that static handle.

As disclosed above, a storage system may have one or more VHD associated with a single VHD Set File. Each of those VHD may have the storage provide by the use of a VHD file (e.g., using the VHDX file format), may have the storage provided by a log file that records actions (e.g., writes to the VHD), or combinations of the above.

The above description relates to snapshot creation. In addition to requesting the creation of a snapshot, examples herein provide mechanisms which provide a requestor with the ability to request the performance of different operations on a VHD. For example, a requestor may send a message to the storage system to request performance of an extract operation. In examples, the request may comprise a SVHDX_META_OPERATION_START_REQUEST message that includes an OperationType field that may be set to with a SvhdxMetaOperationTypeExtractVHD flag or value. The request may also specify a SnapshotType (e.g., a single snapshot indicated by the SvhdxSnapshotTypeVM flag or a continuous data protection snapshot indicated by the SvhdxSnapshotTypeCDP flag), a DestinationVhdSetNameLength field, and a DestinationVhdSetName field. The message may also include a SourceSnapshotId snapshot identifier that is associated with snapshot of a virtual hard disk file associated with a virtual hard disk set file. The storage system may use the provided snapshot identifier to extract the snapshot associated with the identifier. If the snapshot associated with the snapshot identifier was initialized with a continuous data protection indicator, the extracted snapshot may comprise a log file containing the changes that have occurred within the VHD. In other examples, the extracted snapshot may contain the data that was stored by the associated snapshot at the time the snapshot was created. In some examples, the request may also include a SourceLimitSnapshotId snapshot identifier that indicates that a range of snapshots should be included, starting with the first snapshot specified by the SourceSnapshotId and ending with the last snapshot specified by the SourceLimitSnapshotId.

A requestor may also send a message to the storage system to request performance of a convert operation on a specified VHD. In examples, the request may comprise a SVHDX_META_OPERATION_START_REQUEST message, comprising an OperationType field that may be set to the SvhdxMetaOperationTypeConvertToVHDSet flag. The message may specify a DestinationVhdSetNameLength and a DestinationVhdSetName. In response to the request, the storage system may then convert the specified VHD to an updated format that allows the snapshot creation functionality discussed above. The updated format may create a VHD set file and associate the VHD set file with the specified VHD.

A requestor may send a message to the storage system to request performance of a resize operation on a specified VHD. In examples, the request may comprise a SVHDX_META_OPERATION_START_REQUEST message that includes an OperationType field that may be set to the SvhdxMetaOperationTypeResize flag. The message may specify a NewSize, an ExpandOnly indicator, an AllowUnsafeVirtualSize indicator, and a ShrinkToMinimumSafeSize indicator. The message may include an indication (e.g., ShrinkToMinimumSafeSize) that the VHD should be resized to the minimum safe size while still retaining the data stored by the specified VHD. The minimum safe size of a VHD may be determined to be the size that matches the amount of data currently stored by the VHD, such that no stored data is truncated but no additional free space remains after the resize operation. The request may also include an indication that the VHD can only be expanded, not shrunk. Such indication may be in the form of a flag or a value, such as, for example, the ExpandOnly flag. In examples, the request may include a desired size (e.g., NewSize) for the specified VHD. The request may also include an indication (e.g., AllowUnsafeVirtualSize) that the resize operation should be performed even if the resulting VHD size is less than the amount of data currently stored by the VHD. The storage system may then resize the specified VHD based on the information provided by the requestor.

A requestor may send a message to the storage system to request performance of a query operation on a specified VHD or associated VHD snapshot. In examples, the request may comprise a SVHDX_TUNNEL_VHDSET_QUERY_INFORMATION_REQUEST message. The request may specify a SnapshotType. Further, the request may specify a VHDSetInformationType. The VHDSetInformationType field indicates to the storage system the kind of information that is being requested. For example, the field provides an indication as to whether the client is requesting a list of snapshots (e.g., SvhdxVHDSetInformationTypeSnapshotList), requesting details about a specific snapshot entry (e.g., SvhdxVHDSetInformationTypeSnapshotEntry), querying whether the specified virtual hard disk needs optimization (e.g., SvhdxVHDSetInformationTypeOptimizeNeeded), requesting the oldest continuous data protection snapshot available (e.g., SvhdxVHDSetInformationTypeCdpSnapshotRoot), requesting a list of continuous data protection snapshots that are active (e.g., SvhdxVHDSetInformationTypeCdpSnapshotActiveList), or requesting a list of continuous data protection snapshots that are inactive (e.g., SvhdxVHDSetInformationTypeCdpSnapshotInactiveList). In examples, the request may include a snapshot identifier. The storage system may respond with the information requested by the requestor.

A requestor may send a message to the storage system to request performance of a delete operation on a specified VHD. In examples, the request may comprise a SVHDX_TUNNEL_DELETE_SNAPSHOT_REQUEST message. The request may specify a SnapshotId and SnapshotType. In certain examples, the request to delete the VHD may include an indication (e.g., a PersistReference indicator) that the snapshot should be persisted. When the snapshot is to be persisted, rather than deleting the snapshot, the snapshot may be converted to a reference point within the associated VHD set file. A snapshot converted to a reference point may instead provide a list of locations in a file that have changed rather than providing the actual underlying data. This reduces the amount of space required by the snapshot but still allows the storage system to provide change tracking information to a requestor.

A requestor may send a message to the storage system to request that the storage system enable change tracking for a specified VHD. In examples, the request may comprise a SVHDX_CHANGE_TRACKING_START_REQUEST message. The request may include a LogFileNameLength, a LogFileName, a MaxLogFileSize, and an AppendData indication. The storage system may then monitor the specified VHD and note changes that occur to the VHD after snapshot creation (e.g., in the log file specified by the LogFileNameLength and LogFileName variables). In some examples, the storage system may append data to an existing log file (e.g., as specified by the AppendData indicator). The storage system may limit the log file size to a specified number of bytes (e.g., as specified by the MaxLogFileSize variable). As a result of enabling change tracking, the storage system may then provide change tracking functionality (e.g., reference point conversion as described above).

A requestor may send a message to the storage system to request performance of an optimize operation on a specified VHD. In examples, the request may comprise a SVHDX_META_OPERATION_START_REQUEST message, wherein the OperationType is SvhdxMetaOperationTypeOptimize. The storage system may perform cleanup in order to ensure that resources associated with the specified VHD are not wasted (e.g., storage space required to store the VHD). In some examples, the storage system may clean up unwanted snapshots stored by the associated VHD set file. For example, the storage system may convert snapshots to reference points in order to reduce the amount of space consumed by the VHD.

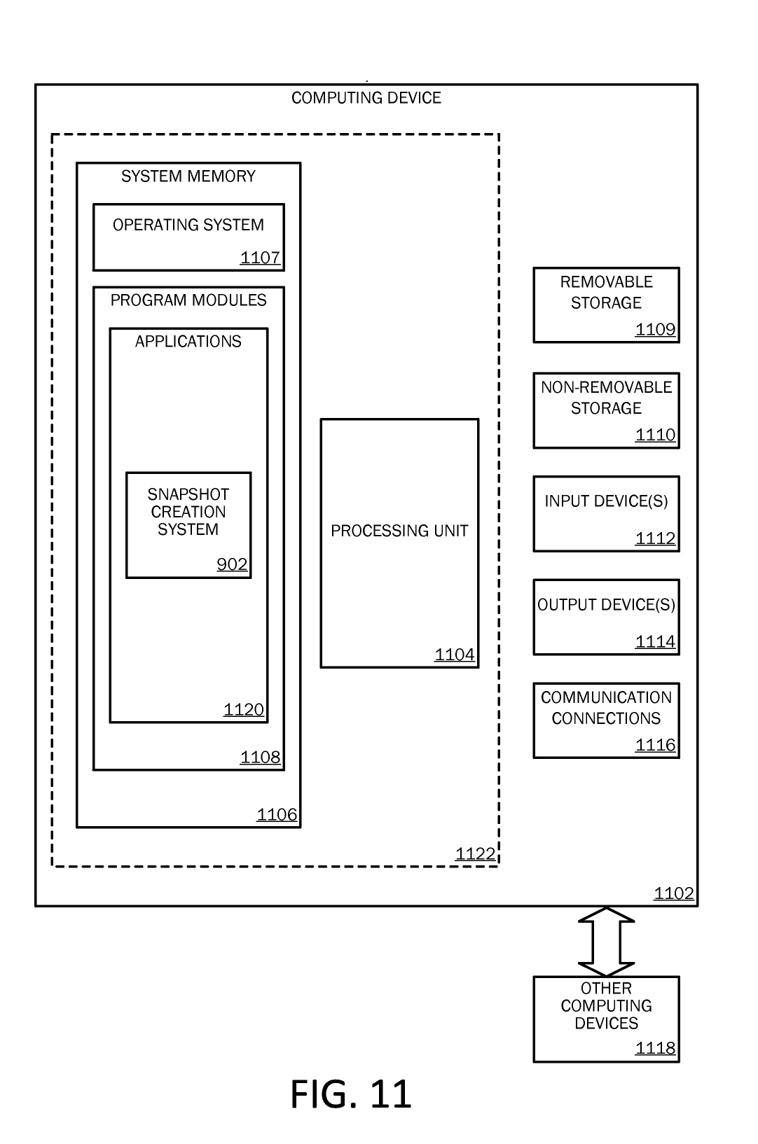

FIGS. 11-13 and the associated descriptions provide a discussion of a variety of operating environments in which examples of the invention may be practiced. However, the devices and systems illustrated and discussed with respect to FIGS. 11-13 are for purposes of example and illustration and are not limiting of a vast number of computing device configurations that may be utilized for practicing examples of the invention, described herein.

FIG. 11 is a block diagram illustrating physical components of a computing device 1102, for example clients 102 and 104 and storage devices 108A, and 108B, with which examples of the present disclosure may be practiced. The computing device components described below may be suitable for the computing devices described above. In a basic configuration, the computing device 1102 may include at least one processing unit 1104 and a system memory 1106. Depending on the configuration and type of computing device, the system memory 1106 may comprise, but is not limited to, volatile storage (e.g., random access memory), non-volatile storage (e.g., read-only memory), flash memory, or any combination of such memories. The system memory 1106 may include an operating system 1107 and one or more program modules 1108 suitable for running software applications 1120 such as snapshot creation process 902. The operating system 1107, for example, may be suitable for controlling the operation of the computing device 1102. Furthermore, examples of the invention may be practiced in conjunction with a graphics library, other operating systems, or any other application program and is not limited to any particular application or system. This basic configuration is illustrated in FIG. 11 by those components within a dashed line 1122. The computing device 1102 may have additional features or functionality. For example, the computing device 1102 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1106. While executing on the processing unit 1104, the program modules 1108 (e.g., snapshot creation process 902, initialization component 904, etc.) may perform processes including, but not limited to, one or more of the stages of the operational flows 300, 400, 500, 600, 700, 800, and 1000 illustrated in FIGS. 3, 4, 5, 6, 7, 8, and 10. Other program modules that may be used in accordance with examples of the present invention may include electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 1102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 1102 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1104 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1106, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1102. Any such computer storage media may be part of the computing device 1102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

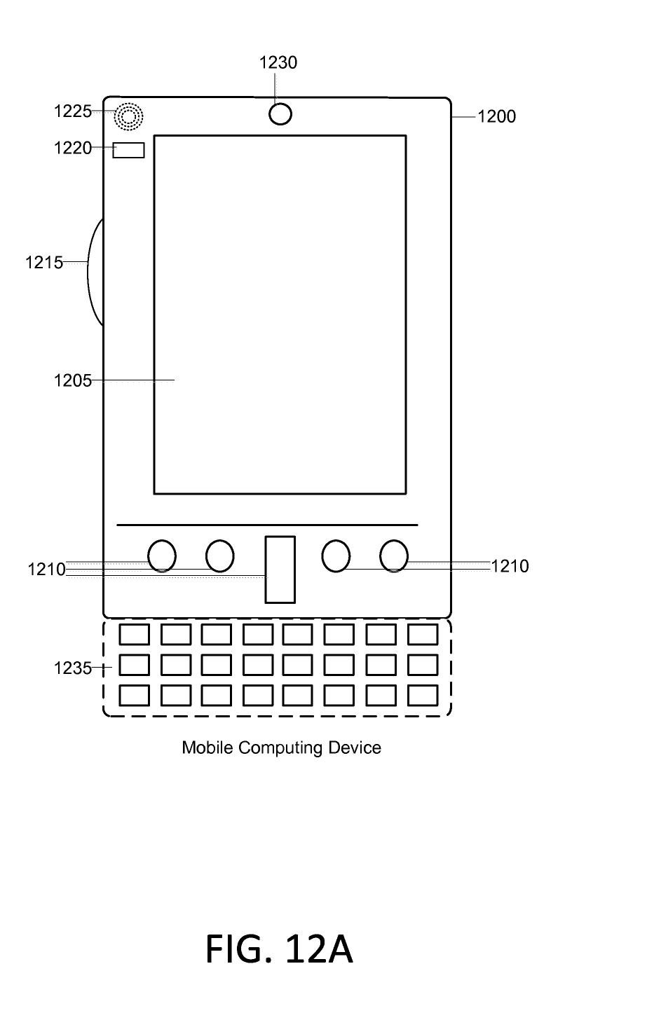

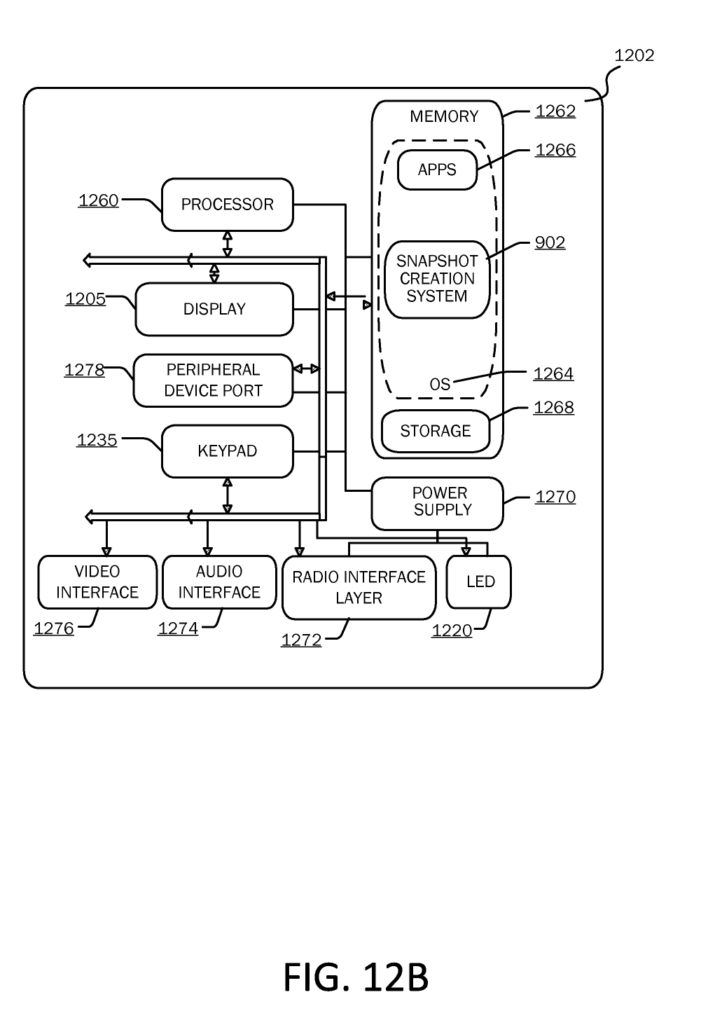

FIGS. 12A and 12B illustrate a mobile computing device 1200, for example, a mobile telephone, a smart phone, a tablet personal computer, a laptop computer, and the like, with which examples of the invention may be practiced. For example, mobile computing device 1200 may be used to implement clients 102 and 104. With reference to FIG. 12A, one example of a mobile computing device 1200 for implementing the examples is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative examples, mobile computing device 1200 may incorporate more or less input elements. For example, the display 1205 may not be a touch screen in some examples. In yet another alternative example, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various examples, the output elements include the display 1205 for showing a graphical user interface (GUI), a visual indicator 1220 (e.g., a light emitting diode), and/or an audio transducer 1225 (e.g., a speaker). In some examples, the mobile computing device 1200 incorporates a vibration transducer for providing the user with tactile feedback. In yet another example, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 12B is a block diagram illustrating the architecture of one example of a mobile computing device. That is, the mobile computing device 1200 can incorporate a system (i.e., an architecture) 1202 to implement some examples. In one examples, the system 1202 is implemented as a “smart phone” capable of running one or more applications (e.g., browser, e-mail, calendaring, contact managers, messaging clients, games, and media clients/players). In some examples, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including snapshot creation process 902 described herein.

The system 1202 has a power supply 1270, which may be implemented as one or more batteries. The power supply 1270 might further include an external power source, such as an AC adapter or a powered docking cradle that supplements or recharges the batteries.

The system 1202 may include peripheral device port 1278 that performs the function of facilitating connectivity between system 1202 and one or more peripheral devices. Transmissions to and from the peripheral device port 1272 are conducted under control of the operating system 1264. In other words, communications received by the peripheral device port 1278 may be disseminated to the application programs 1266 via the operating system 1264, and vice versa.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated example, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with examples of the present invention, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 12B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

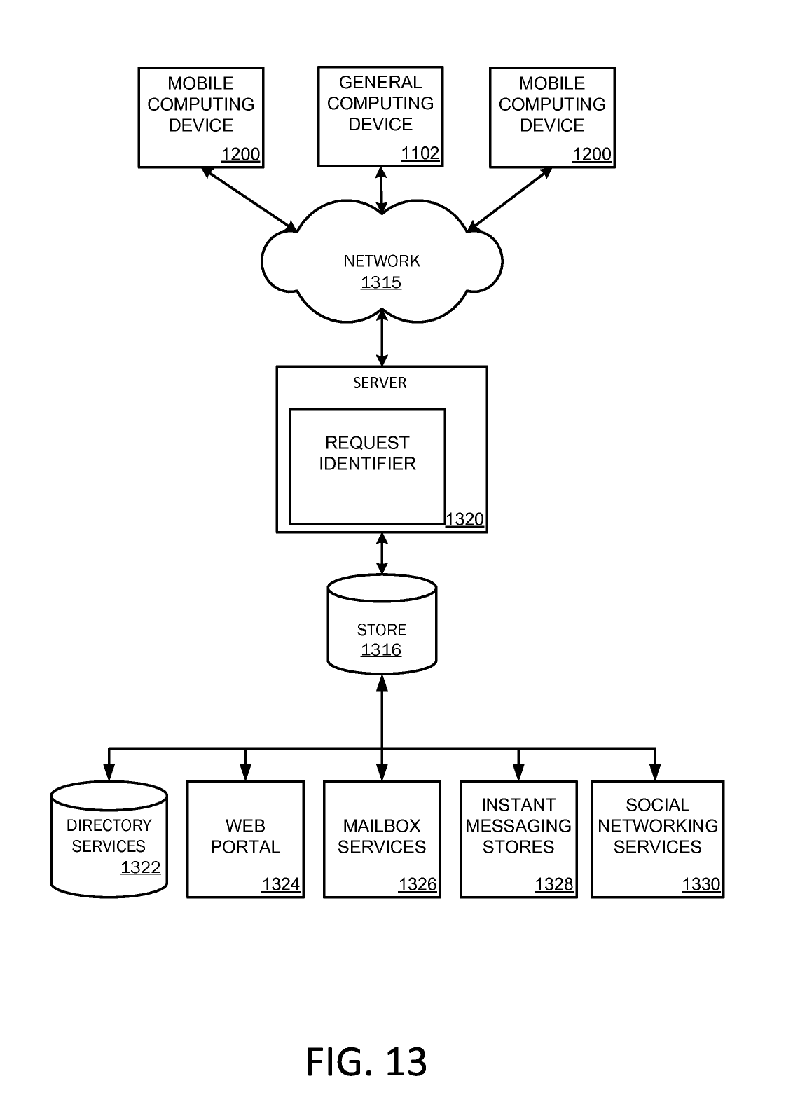

FIG. 13 illustrates one example of the architecture of a system for providing accessing VHDs and creating snapshots as described above. VHDs accessed, interacted with, or edited in association with snapshot creation process 802 and/or instructions to perform the methods disclosed herein may be stored in different communication channels or other storage types. For example, various documents may be stored using a directory service 1322, a web portal 1324, a mailbox service 1326, an instant messaging store 1328, or a social networking site 1330. Snapshot creation process 902 may use any of these types of systems or the like for enabling data utilization, as described herein. A server 1320 may provide storage system 108 for use by clients 102 and 104 operating on general computing device 1102 and mobile device(s) 1200 through network 1315. By way of example, network 1315 may comprise the Internet or any other type of local or wide area network, and the clients 102 and 104 may be implemented as a computing device 1102 embodied in a personal computer, a tablet computing device, and/or by a mobile computing device 1200 (e.g., a smart phone). Any of these embodiments of the client computing device 1102 or 1200 may obtain content from the store 1316.

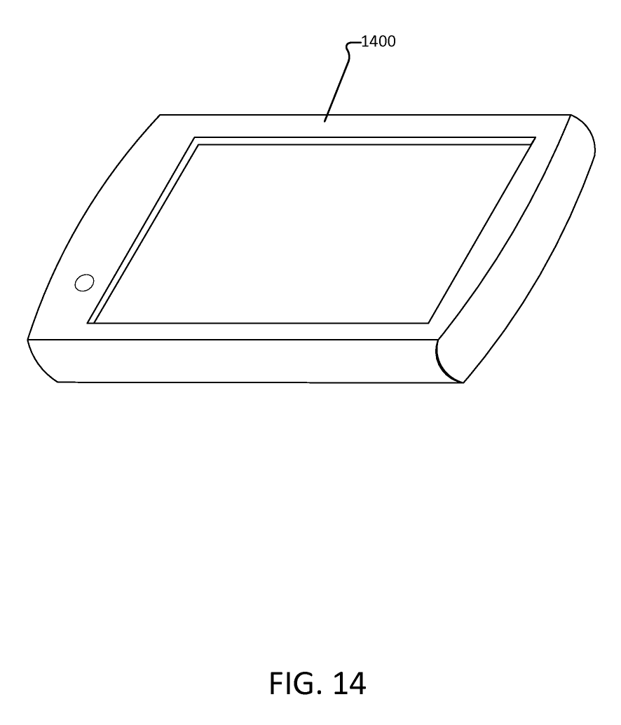

FIG. 14 illustrates an exemplary tablet computing device 1400 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Among other examples, the present disclosure presents a system for creating a snapshot of a virtual hard disk, comprising: at least one processor; and memory, operatively connected to the at least one processor and containing instructions that, when executed by the at least one processor, perform a method, the method comprising: opening a handle to a virtual hard disk set file; accessing the virtual hard disk using the handle, wherein the virtual hard disk comprises a first virtual hard disk file, and wherein accessing the virtual hard disk comprises writing at least a first sector of data to the virtual hard disk; requesting creation of a snapshot of the virtual hard disk file, wherein the snapshot comprises the first sector of data; after the snapshot of the virtual hard disk is created, accessing the virtual hard disk using the handle, wherein accessing the virtual hard disk comprises writing at least a second sector of data to the virtual hard disk. In further examples, the method further comprises: requesting a list of snapshots; and receiving a list of snapshots. In further examples, the list of snapshots is requested using the handle to the virtual hard disk set file. In further examples, a second virtual hard disk file is created in response to the request to create the snapshot. In further examples, the second sector of data is written to the second virtual hard disk file. In further examples, snapshot comprises the first hard disk file. In further examples, the method further comprises: requesting creation of a second snapshot; and after requesting creation of the second snapshot, writing at least a third sector of data to the virtual hard disk using the handle, wherein the third sector of data is written to a third virtual hard disk. In further examples, accessing the virtual hard disk and writing the first and second sectors are via a Tunnel Operation SCSI pass through request. In further examples, as a result of creating the snapshot, access requests issued for the virtual hard disk are redirected from the first virtual hard disk file to a second virtual hard disk file.

Additional aspects disclosed herein provide a method for creating a snapshot of a virtual hard disk, the method comprising: initializing a second virtual hard disk, wherein initializing comprises creating an empty virtual hard disk file, initializing file headers, and receiving an indication that periodic snapshots should be created; blocking I/O requests, wherein blocking I/O requests comprises holding I/O requests directed to the first virtual hard disk and instead storing the I/O requests in a data store for later delivery; switching the target of I/O requests from the first virtual hard disk to the second virtual hard disk; unblocking I/O requests, wherein unblocking I/O requests comprises delivering I/O requests from the data store to the second virtual hard disk and allowing subsequent I/O requests directed to the second virtual hard disk; and finalizing the second virtual hard disk, wherein finalizing comprises cleaning up temporary data that was stored while creating the snapshot. In further examples, the method further comprises: after a predetermined period of time, initializing a third virtual hard disk, blocking I/O requests, switching the target of I/O requests from the second virtual hard disk to the third virtual hard disk, unblocking I/O requests, and finalizing the third virtual hard disk. In further examples, receiving an indication comprises receiving a log file name. In further examples, the method further comprises: logging snapshot creation progress to a log file indicated by the log file name. In further examples, initializing further comprises updating a virtual hard disk set file to point to the second virtual hard disk file. In further examples, initializing further comprises adding an entry to the virtual hard disk set file to indicate that the snapshot is being created. In further examples, blocking I/O requests further comprises blocking I/O requests for the entire virtual hard disk. In further examples: switching the target of I/O requests further comprises redirecting I/O requests from the first virtual hard disk file to the second virtual hard disk file. In further examples, wherein unblocking I/O requests further comprises redirecting I/O requests from the first virtual hard disk file to the second virtual hard disk file. In further examples, a single operation may comprise two or more stages selected from the group consisting of initializing the second virtual hard disk file, blocking I/O requests, switching the target of I/O request, unblocking I/O requests, and finalizing the snapshot creation process.

Additional aspects of the present disclosure provide a system comprising: initialization means for initializing a snapshot of a first virtual hard disk; blocking means for blocking I/O requests directed to the first virtual hard disk; target switching means for switching a target of an I/O request from the first virtual hard disk to a second virtual hard disk; unblocking means for unblocking subsequent I/O requests; and finalization means for finalizing the second virtual hard disk.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While example examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

We claim:

1. A system for creating a snapshot of a virtual hard disk, comprising:
at least one processor; and
memory, operatively connected to the at least one processor and containing instructions that, when executed by the at least one processor, perform a method, the method comprising:
opening a handle to a virtual hard disk set file;
accessing the virtual hard disk using the handle, wherein the virtual hard disk comprises a first virtual hard disk file, and wherein accessing the virtual hard disk comprises writing at least a first sector of data to the virtual hard disk;
requesting creation of a snapshot of the virtual hard disk file, wherein the snapshot comprises the first sector of data;
after the snapshot of the virtual hard disk is created, accessing the virtual hard disk using the handle, wherein accessing the virtual hard disk comprises writing at least a second sector of data to the virtual hard disk.

2. The system of claim 1, wherein the method further comprises:
requesting a list of snapshots; and
receiving a list of snapshots.

3. The system of claim 2, wherein the list of snapshots is requested using the handle to the virtual hard disk set file.

4. The system of claim 1, wherein a second virtual hard disk file is created in response to the request to create the snapshot.

5. The system of claim 4, wherein the second sector of data is written to the second virtual hard disk file.

6. The system of claim 4, wherein the snapshot comprises the first hard disk file.

7. The system of claim 1, wherein the method further comprises:
requesting creation of a second snapshot; and
after requesting creation of the second snapshot, writing at least a third sector of data to the virtual hard disk using the handle, wherein the third sector of data is written to a third virtual hard disk.

8. The system of claim 1, wherein accessing the virtual hard disk and writing the first and second sectors are via a Tunnel Operation SCSI pass through request.

9. The system of claim 1, wherein, as a result of creating the snapshot, access requests issued for the virtual hard disk are redirected from the first virtual hard disk file to a second virtual hard disk file.

10. A method for creating a snapshot of a virtual hard disk, the method comprising:
initializing a second virtual hard disk, wherein initializing comprises creating an empty virtual hard disk file, initializing file headers, and receiving an indication that periodic snapshots should be created;
blocking I/O requests, wherein blocking I/O requests comprises holding I/O requests directed to the first virtual hard disk and instead storing the I/O requests in a data store for later delivery;
switching the target of I/O requests from the first virtual hard disk to the second virtual hard disk;
unblocking I/O requests, wherein unblocking I/O requests comprises delivering I/O requests from the data store to the second virtual hard disk and allowing subsequent I/O requests directed to the second virtual hard disk; and
finalizing the second virtual hard disk, wherein finalizing comprises cleaning up temporary data that was stored while creating the snapshot.

11. The method of claim 10, further comprising:
after a predetermined period of time, initializing a third virtual hard disk, blocking I/O requests, switching the target of I/O requests from the second virtual hard disk to the third virtual hard disk, unblocking I/O requests, and finalizing the third virtual hard disk.

12. The method of claim 10, wherein receiving an indication comprises receiving a log file name.

13. The method of claim 12, further comprising:
logging snapshot creation progress to a log file indicated by the log file name.

14. The method of claim 10, wherein initializing further comprises updating a virtual hard disk set file to point to the second virtual hard disk file.

15. The method of claim 10, wherein initializing further comprises adding an entry to the virtual hard disk set file to indicate that the snapshot is being created.

16. The method of claim 10, wherein blocking I/O requests further comprises blocking I/O requests for the entire virtual hard disk.

17. The method of claim 10, wherein switching the target of I/O requests further comprises redirecting I/O requests from the first virtual hard disk file to the second virtual hard disk file.

18. The method of claim 10, wherein unblocking I/O requests further comprises redirecting I/O requests from the first virtual hard disk file to the second virtual hard disk file.

19. The method of claim 10, wherein a single operation may comprise two or more stages selected from the group consisting of initializing the second virtual hard disk file, blocking I/O requests, switching the target of I/O request, unblocking I/O requests, and finalizing the snapshot creation process.

20. A system comprising:
initialization means for initializing a snapshot of a first virtual hard disk;
blocking means for blocking I/O requests directed to the first virtual hard disk;
target switching means for switching a target of an I/O request from the first virtual hard disk to a second virtual hard disk;
unblocking means for unblocking subsequent I/O requests; and
finalization means for finalizing the second virtual hard disk.
